(19) United States
(12) Patent Application Publication
(10) Pub. No.: US 2004/0104518 A1
(43) Pub. Date: Jun. 3, 2004

(54) Double-walled, blow-molded, poly(vinyl chloride) article and method of making same

(76) Inventor: Gary S. Henneberry, Mount Holly, NJ (US)

Correspondence Address: John H. Hornickel, PolyOne Corporation, 33587 Walker Road, Avon Lake, OH, 44012, US

(21) Appl. No.: 10/714,006

(22) Filed: Nov. 14, 2003

Related U.S. Application Data
(60) Provisional application No. 60/429,522, filed on Nov. 27, 2002.

(51) Int. Cl. B29C 49/04

(52) U.S. Cl. 264/540; 428/542.8

(57) ABSTRACT

Formulations of poly(vinyl chloride) are disclosed that have properties to endure the rigors of continuous extrusion blow molding to form double-walled, blow-molded poly(vinyl chloride) articles. The formulations satisfy a test that each formulation has a 40 cm parison formation time of at least 40 seconds.

### FIELD OF THE INVENTION

This invention relates to the manufacture of double-walled articles made of poly(vinyl chloride) using blow molding techniques.

### BACKGROUND OF THE INVENTION

People benefit from plastic articles. From their invention in the mid-20^{th} Century until the present, thermoplastic polymers have become the composition of many consumer products. Such products are relatively lightweight, sturdy, and corrosion resistant.

Plasticized poly(vinyl chloride), invented by Waldo Semon of B.F. Goodrich, has been a top performing plastic resin for decades. Millions of kilograms of poly(vinyl chloride) (also known as “PVC”) resin are molded each year into countless products. With conventional additives, poly(vinyl chloride) provides unparalleled durability, flame resistance, and clarity.

However, poly(vinyl chloride) resin has certain well-known manufacturing limitations. Because of its sensitivity to heat, its use as a resin in extrusion blow molding processes has been limited because most blow molding equipment to make double-walled articles uses a heated accumulator at the head of the equipment. Temperatures in the accumulator head can reach about 175° C. At this elevated temperature, PVC can degrade. Moreover, continuous extrusion blow molding has not been used to make double-walled or large single-walled articles from PVC because the compound lacks sufficient melt strength to be continuously extruded into long or large parisons. Without sufficient melt strength, the parison stretches excessively due to its own weight.

Thus, double-walled poly(vinyl chloride) articles have not been made by extrusion blow molding processes. This is a disadvantage because a plastic resin with very desirable properties is not known to be available for making double-walled articles using the blow molding extrusion process, which is capable of making intricately configured, large plastic articles.

### SUMMARY OF THE INVENTION

What the art needs is a method to make double-walled articles from poly(vinyl chloride) using a blow molding processing technique.

The present invention solves that problem in the art by using a formulation of poly(vinyl chloride) that has properties to endure the rigors of continuous extrusion blow molding to form double-walled, blow-molded poly(vinyl chloride) articles. Preferably, such double-walled, blow-molded poly(vinyl chloride) articles can achieve a length in the longest dimension ranging from about 10 inches to about 50 inches (about 25 to about 127 cm). More preferably, such double-walled, blow-molded poly(vinyl chloride) articles can achieve a length in the second-longest dimension ranging from about 6 inches to about 30 inches (about 15 to about 76 cm).

Thus, the present invention can make double-walled, blow-molded poly(vinyl chloride) articles ranging in area from about 60 in² (about 388 cm²) to about 1500 in (about 9677 cm²).

Within that range of area, the thickness for a double-walled, blow-molded poly(vinyl chloride) article can range from about 0.375 inches to about 3 inches (about 0.95 to about 7.6 cm).

Thus, the present invention can make double-walled, blow-molded poly(vinyl chloride) articles ranging in volume from about 22.5 in³ to about 4500 in³ (about 368 cm³ to about 11,400 cm³), where the longest dimension is at least 10 inches (about 25 cm) and the next longest dimension is at least 6 inches (about 15 cm).

Previously, it was not known that poly(vinyl chloride) could be made via continuous extrusion techniques into a double-walled, blow-molded article of any size.

One aspect of the invention is a method of making a making a double-walled poly(vinyl chloride)-containing article, comprising the steps of: (a) melting a composition containing poly(vinyl chloride); (b) continuously extruding the composition in the form of a parison, wherein the composition is made from a formulation having a 40 cm parison formation time of at least 40 seconds; and (c) blow molding the parison into a desired shape.

Another aspect of the invention is a doubled-walled, blow-molded poly(vinyl chloride) article made according to the method of the present invention.

A feature of the present invention is that the continuous extrusion blow molding process minimizes the residence time of the poly(vinyl chloride) resin in the extruding equipment so as to minimize any deleterious effect of the heat of the equipment on the poly(vinyl chloride) flowing through that equipment.

Another feature of the present invention is that poly(vinyl chloride) is formulated to have sufficient melt elasticity to permit the formation of a parison having enough strength for use in continuous extrusion blow molding processing.

Expressed another way, the formulation of the poly(vinyl chloride) for the present invention should have a time of formation of a parison of at least 16 inches (40 cm) to be at least 40 seconds. This “40 cm parison formation time” of at least 40 seconds reveals the melt elasticity of the poly(vinyl chloride), not the requirements of parison length or cycle time for any particular continuous extrusion. Rather, the present invention uses this test to characterize the physical properties of the formulation as an index to the practical reality of formulation performance within any continuous extrusion process to make double-walled, blow-molded poly(vinyl chloride) articles ranging in area from about 60 in² (about 388 cm²) to about 1500 in² (about 9677 cm²).

An advantage of the present invention is the ability to form double-walled, blow-molded plastic articles from poly(vinyl chloride) resin, permitting a wide range of plastic products to benefit from the well-known and desired properties of poly(vinyl chloride) resin, such as flame resistance, weatherability and other durability, clarity, pigmented durability, etc. Double-walled articles provide desired electrical insulation and possible thermal insulation, making the combination of structure and composition of articles of the present invention very desirable for uses where electrical insulation is mandated by regulatory authorities.

Another advantage of the present invention is that poly(vinyl chloride) can be molded using a commonly used, very economical molding technique to achieve articles which can have intricate interior cavities, textured exteriors, or both, depending on the mold pieces chosen by the plastic resin artisan.

Additional features and advantages will become apparent in the discussion of embodiments.

### EMBODIMENTS OF THE INVENTION

Poly(vinyl chloride)

A poly(vinyl chloride) containing formulation, for purposes of this invention, can include poly(vinyl chloride) homopolymer, one or more copolymers of poly(vinyl chloride), or polymeric blends or alloys that contain poly(vinyl chloride) homopolymer(s) or copolymer(s) as ingredient(s) thereof.

Poly(vinyl chloride) is a common commodity thermoplastic polymer. Vinyl chloride monomer is made from a variety of different processes such as the reaction of acetylene and hydrogen chloride and the direct chlorination of ethylene. Poly(vinyl chloride) is typically manufactured by the free radical polymerization of vinyl chloride resulting in a useful thermoplastic polymer. After polymerization, poly(vinyl chloride) is commonly combined with thermal stabilizers, lubricants, plasticizers, organic and inorganic pigments, fillers, biocides, processing aids, flame retardants and other commonly available additive materials. Poly(vinyl chloride) can also be combined with other vinyl monomers in the manufacture of poly(vinyl chloride) copolymers. Such copolymers can be linear copolymers, branched copolymers, graft copolymers, random copolymers, regular repeating copolymers, block copolymers, etc. Monomers that can be combined with vinyl chloride to form vinyl chloride copolymers include a acrylonitrile; alpha-olefins such as ethylene, propylene, etc.; chlorinated monomers such as vinylidene dichloride, acrylate momoners such as acrylic acid, methylacrylate, methylmethacrylate, acrylamide, hydroxyethyl acrylate, and others; styrenic monomers such as styrene, alphamethyl styrene, vinyl toluene, etc.; vinyl acetate; and other commonly available ethylenically unsaturated monomer compositions.

Such monomers can be used in an amount of up to about 50 mole percent (mol-%), the balance being vinyl chloride. Polymer blends or polymer alloys can be useful in manufacturing the double-walled articles of the present invention. Such alloys typically comprise two miscible polymers blended to form a uniform composition.

Poly(vinyl chloride) forms a number of known polymer alloys including, for example, poly(vinyl chloride)/nitrile rubber; poly(vinyl chloride) and related chlorinated copolymers and terpolymers of poly(vinyl chloride) or vinylidene dichloride poly(vinyl chloride)/alphamethyl styrene-acrylonitrile copolymer blends, poly(vinyl chloride)/polyethylene; poly(vinylchloride)/chlorinated polyethylene and others.

Poly(vinyl chloride) homopolymers, copolymers, and polymer alloys are available from a number of manufacturers including PolyOne Corporation of Avon Lake, Ohio.

For use in the present invention, preferred poly(vinyl chloride) containing formulations are poly(vinyl chloride) homopolymers having a weight average molecular weight of from about 40×10³ to about 99×10³, and preferably from about 50×10³ to about 80×10³.

To facilitate continuous extrusion processing, poly(vinyl chloride) containing formulations should have a high melt viscosity under the low shear forces acting on the extrudate, preventing sagging and drooling during continuous flow of extrudate, while at the same time, exhibiting significantly lower melt viscosities under the high shear rate conditions existing in the extruder die, facilitating the passage of the melt through the die without requiring excessive pressures in the extruder barrel.

To accomplish such polymer engineering preferences, poly(vinyl chloride) useful in the present invention should have a melt elasticity characterized by the relative viscosity of the poly(vinyl chloride) resin in combination with the amount of processing aid to reduce torque stress on the extrusion equipment. The following Table 1 identifies variances in these parameters, compared with formulations, which have not satisfied the “40 cm parison formation time” test.

Relative viscosity, related to dilute solution viscosity, is measured using ASTM Test Method D2857-95. Processing aids are added to control melt elasticity, fusion, and die-swell properties, and otherwise improve the rheological properties of the compound during manufacturing. Any processing aid known to those skilled in the art that satisfies the relative viscosity value is acceptable for use in the present invention.

TABLE 1

| | Relative Viscosity | | Amount of |
|---|---|---|---|
| | of Poly(vinyl | Relative Viscosity | Processing Aid |
| Example | chloride) Resin | of Processing Aid | (Wt. %) |
| 1 | 1.55 | 0.25-0.35 | 3.0 |
| 2 | 1.55 | 0.72-1.0 | 2.0 |
| 3 | 1.85 | 0.25-0.35 | 2.8 |
| 4 | 1.85 | 0.72-1.0 | 1.8 |
| 5 | 1.90 | 0.25-0.35 | 2.3 |
| 6 | 1.90 | 0.25-0.35 | 2.6 |
| 7 | 1.90 | 0.72-1.0 | 1.6 |
| 8 | 2.00 | 0.25-0.35 | 2.2 |
| 9 | 2.00 | 0.72-1.0 | 1.2 |
| 10 | 2.20 | 0.25-0.35 | 1.6 |
| 11 | 2.20 | 0.72-1.0 | 0.9 |
| Comparison A | 1.55 | 0.25-0.35 | 2.0 |
| Comparison B | 1.85 | 0.3-0.4 | 1.4 |
| Comparison C | 1.90 | 0.3-0.4 | 1.3 |
| Comparison D | 1.90 | 0.3-0.4 | 1.7 |

The selection of a specific relative viscosity for the processing aid determines what weight percent of processing aid to add, for any given relative viscosity of poly(vinyl chloride) resin. For example, Example 1 adds 50% more processing aid than Comparison Example A at a given relative viscosity of 1.55 for the poly(vinyl chloride) resin, in order to meet the test of 40 cm parison formation time of at least 40 seconds. A comparison of Example 3 and Comparison Example B shows 100% more processing aid is needed for similar relative viscosity processing aid. Finally, between 35% and 100% more processing aid is needed for a 1.90 viscosity poly(vinyl chloride) resin, as seen by a comparison of Examples 5-6 with Comparison Examples C-D.

If a higher relative viscosity processing aid is used, the amount added can be reduced, when compared with the amount of lower relative viscosity processing aid used. For example, given a poly(vinyl chloride) resin of 1.55 relative viscosity, a direct comparison of Example 2 with Comparison Example A shows the same amount of processing aid used but an increase in the relative viscosity of the processing aid of about 100-400%.

Optional ingredients in the poly(vinyl chloride) formulation include lubricants, pigments, fillers, UV stabilizers, and low levels of synthetic fibers (such as glass, carbon, polyamide etc), die-modifiers, impact-modifiers, and combinations thereof.

Poly(vinyl chloride) containing formulations are commercially available in convenient handling forms. Resin particle flake or pellet sizes should be in the range of from 0.1 to 10 mm, and preferably 0.5 to 5 mm, to facilitate processing as taught in U.S. Pat. No. 5,536,462 (Hawrylko), the disclosure of which is incorporated herein by reference.

Continuous Extrusion Blow Molding

Extrusion blow molding typically comprises extruding a tube of plastic into a water-cooled mold, inflating the tube by internally introducing air or another gas until the walls of the molten tube assume the shape of the mold, allowing the shaped tube to cool to structural rigidity, and removing the extrusion blow molded part from the mold. In continuous extrusion blow molding, the parison is continuously formed at the same rate as the article is molded, cooled, and removed. To avoid interference with the parison formation, the mold-clamping mechanism (usually two mold halves having desired shapes for intricate interior and exterior surface article molding) must move quickly to capture the parison and return it to a blowing station where a blow pin enters. The mold-clamping mechanism can reside at the same level as the parison during its formation but about a different axis from the axis of the parison. Alternatively, the mold-clamping mechanism can reside coaxially with the parison but in a lower level from where the parison forms, the so-called rising-mold method.

Further information about continuous extrusion blow molding can be found in Irwin, “Blow Molding” in Encyclopedia of Polymer Science and Engineering, 2^{nd} Ed. (Mark et al.) Vol. 2, pp. 447-478 (Wiley-Interscience 1985) with “continuous extrusion blow molding” being discussed specifically at pp. 450-453 and 467-474. The disclosure of this article is incorporated by reference as if rewritten herein. Further, one skilled in the art can refer to U.S. Pat. No. 4,419,485 (Borman et al.), the disclosure of which is incorporated by reference herein.

### USEFULNESS OF THE INVENTION

Articles made from the combination of the poly(vinyl chloride) containing formulation and the continuous extrusion blow molding technique permit sizes of double-walled cavity-containing articles previously impossible. A wide variety of thermoplastic articles is now possible.

Non-limiting examples of articles capable of being molded according to the present invention include motor vehicle fluid receptacle parts (such as fuel tanks, fluid reservoirs, etc.); modular bricks for retaining walls, athletic equipment and toys (such as support bases for moveable volleyball nets); lawn furniture; flexible bellows; and the like. A particularly preferred use is a junction box for low voltage wires and cables for residential and industrial use. The poly(vinyl chloride) formulation provides valuable flame resistance and electrical insulation not possible in blow molded articles made of polyolefins.

The cavity within the article can be unsupported or supported by posts or columns according to the desired final strength of the article. Variations in mold-making known to those skilled in the art can be performed to create the shape of the desired interior cavity of the article.

The exterior of the article can be smooth or textured according to the ornamental preferences of consumer. Again, the mold-maker is capable of satisfying such preferences.

The article can be a single integral piece or a combination of two or more pieces, connected by fasteners. For example, a junction box can have two double-walled shells joined on one side by hinging mechanism. The two shells can be joined by a conventional metal or plastic pin. A single integral double-walled article can have flexible portions to provide a living hinge.

The article, or pieces of a combination of articles, can be clear, translucent, or opaque and colored naturally or with one or more pigments. The selection of formulations to accomplish these options is well within the skill of an artisan without undue experimentation. In the case of a junction box, the mounting shell can be gray and opaque and the opposing shell can be clear for viewing of the wires and cables joined inside. Selection of appropriate formulations can be assisted by reference to the Vinyls business of PolyOne Corporation.

The invention is not limited to the above embodiments. The claims follow.

What is claimed is:

1. A method of making a making a double-walled poly(vinyl chloride)-containing article, comprising the steps of:
(a) melting a composition containing poly(vinyl chloride);
(b) continuously extruding the composition in the form of a parison, wherein the composition is made from a formulation having a 40 cm parison formation time of at least 40 seconds; and
(c) blow molding the parison into a desired shape.

2. The method of claim 1, wherein the composition comprises a processing aid added in a concentration based on its relative viscosity compared with a given relative viscosity of the poly(vinyl chloride) resin.

3. The method of claim 1, wherein the composition further comprises thermal stabilizers, lubricants, plasticizers, organic and inorganic pigments, fillers, biocides, flame retardants, lubricants, pigments, fillers, UV stabilizers, die-modifiers, impact-modifiers, or combinations thereof.

4. The method of claim 1, further comprising steps:
(d) cooling the molded article; and
(e) removing the molded article, wherein the parison continuously forms at the same rate as the article is molded, cooled, and removed.

5. The method of claim 1, wherein the desired shape comprises motor vehicle fluid receptacle parts; modular bricks for retaining walls; athletic equipment; toys; lawn furniture; flexible bellows; junction boxes for low voltage wires and cables; or combinations thereof.

6. A poly(vinyl chloride)-containing article, comprising:
poly(vinyl chloride) in a formulation having a 40 cm parison formation time of at least 40 seconds.

7. The article of claim 6, wherein the formulation further comprises a processing aid added in a concentration based on its relative viscosity compared with a given relative viscosity of the poly(vinyl chloride) resin.

8. The article of claim 7, wherein the formulation further comprises thermal stabilizers, lubricants, plasticizers, organic and inorganic pigments, fillers, biocides, flame retardants, lubricants, pigments, fillers, UV stabilizers, die-modifiers, impact-modifiers, or combinations thereof.

9. The article of claim 6, wherein the article is in a shape of a motor vehicle fluid receptacle part; a modular brick for a retaining wall; athletic equipment; a toy; lawn furniture; a flexible bellow; or a junction box for low voltage wires and cables.
